(19) United States
(12) Patent Application Publication
(10) Pub. No.: US 2022/0174489 A1
(43) Pub. Date: Jun. 2, 2022

(54) Free Access to Proprietor-Controlled Data on a Portable Electronic Device

(71) Applicants: Scott T. Janney, Suffolk, VA (US); Lauren K. Janney, Suffolk, VA (US); Frederick R. Kienle, Yorktown, VA (US)

(72) Inventors: Scott T. Janney, Suffolk, VA (US); Lauren K. Janney, Suffolk, VA (US); Frederick R. Kienle, Yorktown, VA (US)

(21) Appl. No.: 17/109,137

(22) Filed: Dec. 1, 2020

(51) Int. Cl. H04W 12/06; H04W 12/72; H04W 84/02; G06F 16/9035

(52) U.S. Cl. CPC H04W 12/068; G06F 16/9035; H04W 84/02; H04W 12/72

(57) ABSTRACT

User access to proprietor-controlled data through multi-factor authentication over a wireless network using one or more location awareness technologies. The data comprising digital magazines, digital periodicals, videos, television, music, video games and similar media. User access in locations such as waiting rooms, gathering areas and selected venues, through a highly secure, technology supported access that allows waiting, gathering or congregating users to temporarily interact with a wide range of data for free.

### FIELD OF THE INVENTION

The present invention relates generally to the improvement of portable electronic devices. And more particularly, the present invention relates to systems and methods of data exchange between portable electronic devices and proprietor-controlled data.

### BACKGROUND

Anyone who has recently visited a medical provider's office, sat and waited for an appointment with a professional business proprietor, or frequented a local coffee house noted an obvious absence of the usual magazines or similar media in the magazine rack. Because of COVID-19 pandemic-related hygiene concerns, businesses removed reading materials and eliminated magazines in magazine racks. While customers can resort to reading on-line sites on their smart phones or other types of portable electronic devices, they are currently limited by technology applications and connectivity as to what applications or services they routinely view on their own portable electronic devices.

Business owners cannot presently offer the pleasure of reading a magazine to their customers while sitting in a waiting room. Coupled with a movement away from print media and toward digital media, printed publications and hard copy magazines are becoming scarce in waiting rooms and customers can not pass the time while catching up on their favorite periodicals, while waiting for an appointment. Magazines are suffering reduced circulations because of the move away from possibly “germ-contaminated”hard-copy magazines. Magazine advertisers are not reaching their customer segments through traditional advertisements in content-specific magazines. Customers are not being introduced to magazines, their content and their advertisements while waiting for an appointment or drinking a comforting hot beverage. Furthermore, the pandemic provides a unique opportunity to shift away from and modernize the traditional, physical magazine racks and shelves we have come to enjoy in waiting rooms, cafes and other gathering places away from home.

Furthermore, most every waiting room incorporates one or more televisions therein to provide a comfortable experience for customers. But upon doing so some users may not have a desire nor propensity to watch the same proprietor-selected programing or may want to watch different programming or interact with different media. Therefore, there is also a need to improve the types of data that are available for each individual customer, patient or client waiting for an appointment, service, or product.

### SUMMARY OF THE INVENTION

A user database can be provided, for a limited time at a location, to customers seeking entertainment. By offering connectivity to, for example, a digital magazine through the simple use of a displayable computer instruction and a person's own portable electronic device, people can conveniently shift to virtual magazines or similar entertainment media. This invention gives providers and proprietors an opportunity to reach customers by replacing hard-stand and physical traditional media with modern information technology and virtual connectivity provided by the proprietor to a customer.

This invention allows a proprietor to create a user database for their customers, accessible through multi-factor authentication, using a virtual boundary and displayable computer instructions, the displayable computer instructions may be distributed or updated from time to time to ensure proprietors can provide updatable access to digital provider data, such as digital magazines, for customer enjoyment. This invention gives users the opportunity to “sample a magazine” on their portable electronic devices. Subject to user data restrictions, a user can gain access to a user database that is pre-populated with provider data from a proprietor database, and thus a proprietor can control free access for a user to provider data. Upon user data restrictions taking effect, such as through time-limits, data limits, or both, the user may be given the option to subscribe to the provider directly through a provider subscription. In this manner, this invention provides the added benefit of allowing providers to gain access to customers in a new and advantageous way.

In one embodiment, this invention uses a landing page, which may be a website that is resident on the internet, and therefore under this embodiment a user would not be required to install user installed computer readable instructions, such as an application, which sometimes because a nuisance to users, but rather would allow for a user's portable electronic device to use this invention automatically with pre-installed computer readable instructions that are already on the portable electronic device memory.

This invention fills an existential void in the current media distribution and customer service marketplaces. As a result of a steady and continued consumer move away from print media, along with the additional desires to avoid potentially contaminated physical items such as magazines and newspapers during the current pandemic, people are seeking a new way to peruse magazines and read periodical publications in waiting rooms, lounges and on public conveyances such as planes and trains. Magazine racks in doctor's waiting rooms are empty, reading shelves in cafes and lounges are bare, and airlines are not distributing reading materials. This invention is designed to offer customers a short-term solution for access to traditionally subscription-based provider data, such as video, audio, or image files, through a customer's own portable electronic device. As an example, a magazine publisher provider, through this invention, can reach a user by providing the user an opportunity to read an article or entry in a magazine while waiting for an appointment, sipping a purchased beverage, or traveling on a flight. Furthermore, this invention allows a user to interact with provider content on a specific user interface that may be the same or similar to how subscribers may interact with the provider content so as to ensure that users of this invention obtain the equivalent or an improved user experience. When user data restrictions expire, a provider is further benefited as a user customer can then be afforded the opportunity to buy a provider subscription. In this way, this invention fills a void left by the now frequently discontinued hard copies of magazines and other print media previously offered/displayed in physical racks, allows customers to easily select and read a magazine on their own device, and gives magazine publishers a venue for introducing their publications to millions of people in waiting rooms and cafes around the world.

Furthermore, this invention provides for a recordation of user interaction data in a user engagement database that is populated by data tracking techniques. For example, real time monitoring can be achieved through a user's interaction with a user database and/or a proprietor database. This information and usage data can be invaluable to providers. For instance, a provider may be able to obtain information regarding which sets of provider data (e.g. a particular magazine article or a particular video/channel) that is most used or viewed by users which can then be useful in advertising contracts.

Proprietor customized temporary delivery of media to a customer's portable electronic device will address the provision of a more customized, personalized and desirable media engagement and interaction experience. For those customers finding their introduction and engagement to their liking, and desiring to continue the engagement or interactivity beyond the allocated user data restrictions, the customer can elect to enter into a longer term subscription agreement through connectivity on their portable electronic device. In the meantime, the proprietor benefits by improving the experience of his or her customers that may have to wait for his or her products or services.

### BRIEF DESCRIPTION OF THE DRAWINGS

The drawings disclosed herein are for illustration purposes only and are not intended to limit the invention to that which is specifically shown.

FIG. 1 depicts the general components of a portable electronic device.

FIG. 2 depicts a location with a wireless network and virtual boundary.

FIG. 3 depicts a user holding a portable electronic device with a graphical user interface.

FIG. 4 depicts displayable computer instructions.

FIG. 5 depicts a portable electronic device interacting with displayable computer instructions.

FIG. 6 depicts a portable electronic device and target assist features.

FIG. 7 depicts a portable electronic device with a landing page displayed while within a virtual boundary.

FIG. 8 depicts a proprietor computer.

FIG. 9 depicts a proprietor computer at a location facilitating provider data exchange between a user database and a proprietor database.

FIG. 10 depicts a portable electronic device within a virtual boundary exchanging data with a user database under user data restrictions.

FIG. 11 depicts a portable electronic device with a specific user interface to facilitate exchanging data with a user database under the user data restrictions.

FIG. 12 depicts a portable electronic device triggered by user data restrictions and possible further data exchanges with a proprietor database.

FIG. 13 depicts a portable electronic device exiting the virtual boundary.

FIG. 14 depicts a user engagement database.

FIG. 15 depicts a method of user experience with this invention.

FIG. 16 depicts a method of proprietor experience with this invention.

### DETAILED DESCRIPTION

The embodiments below, and in the accompanying drawings, are intended to disclose this invention to a person having ordinary skill in the art. However, this invention is not specifically limited by the few embodiments disclosed herein, but extends beyond these few embodiments as would be understood by a person having ordinary skill in the art.

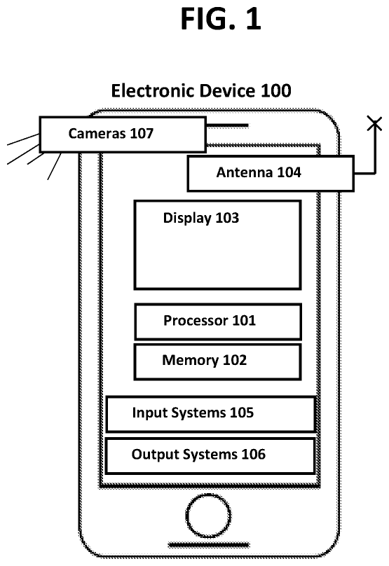

FIG. 1 shows a portable electronic device 100. The portable electronic device may be a user smartphone, tablet, or personal computer but is not intended to be so limited. A portable electronic device as addressed or described within these embodiments may be a portable computer (e.g. laptop), smartwatch, head-mounted display or glasses, or any type of computing device that a user may bring with them for use away from their home. The portable electronic device may generally comprise one or more processors 101, one or more system memories 102, one or more displays 103, one or more antennas 104, one or more input systems 105, one or more output systems 106 and one or more cameras 107.

The one or more antennas 104 may typically include antennas for cellular communications, Wi-Fi communications, Bluetooth communications and/or Global Positioning System (GPS) communications, and other methods, all as is well known by a person of ordinary skill in the art and is not intended to be so limited herein. Generally, the one or more antennas 104 may comprise any antenna apparatus that allows for wireless data communication with a portable electronic device.

The one or more input systems 105 may include various input apparatus as is known by persons with ordinary skill in the art. Examples of such input systems may be a keyboard, touchscreen, various buttons on the portable electronic device, gesture recognition systems, voice recognition/microphone systems, face recognition systems, and various other sensors to detect proximity, light, movement, etc. This invention is not intended to be so limited by any particular input system arrangement or combination.

The one or more output systems 106 may include various output apparatus as is known by persons with ordinary skill in the art. Examples of such output systems may comprise additional displays, lights, speakers, haptic feedback systems, and/or shape variation systems. This invention is not intended to be so limited by any particular output system arrangement or combination.

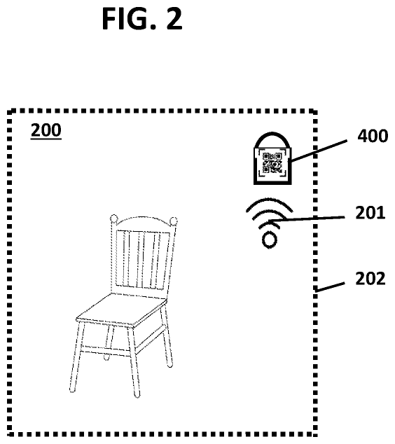

FIG. 2 discloses a location 200. This could be a person's business, home, or similar defined physical space. If the location 200 is a business that is owned by a proprietor, it may be associated with a variety of business types and this invention is not intended to be limited to any particular type of business, profession, or establishment. Examples of proprietors and/or business types could be medical professionals, lawyers dentists, coffee shops, bookstores, libraries, hotels, mechanics, car dealerships, public transportation, and/or generally any type of business where customers, clients or patients may have to wait for a good or service. Additionally, location 200 may be inside an office building or hotel but is not so limited. The location 200 could be outside.

FIG. 2 also discloses a wireless network 201 at the location 200. Wireless networks are generally known by persons having ordinary skill in the art. Wireless network 201 may be a Virtual Private Network (VPN) that provides secure data exchange between a remote memory (not shown) and/or a remote server (not shown) and the processor 101 and a memory 102 via the one or more antennas 104 of the portable electronic device 100. Wireless network 201 may be a cellular network or mobile network as is known by a person having ordinary skill in the art. Wireless network 201 may be one or more different types of networks working concurrently.

FIG. 2 further shows a virtual boundary 202. Virtual boundary 202 may be a triangulated position marker or similar electronic fencing that works with one or more antennas 104 of the portable electronic device 100. Virtual boundary 202 leverages authenticated location awareness technology to create a user or proprietor-defined boundary. More specifically, a proprietor may create a virtual boundary 202 implemented as computer readable instructions stored on a remote memory of a remote server which, through wireless network 201, is securely transferred to portable electronic device 100, via antennas 104, to be then read by processor 101 so as to then use one or more antennas 104 to continuously triangulate a position of portable electronic device 100 in real time. In this manner processor 101 will be triggered as to when portable electronic device 100 is within or outside of virtual boundary 202 as the case may be. Additionally, or alternatively, as the case may be, the virtual boundary 202 may also be established with the use of a Global Positioning System (GPS) and associated antenna 104. The virtual boundary 202 may also be established by the placement of physical detectable objects or sensors at desired points at location 200 so as to establish the virtual boundary 202. Furthermore, the virtual boundary 202 may be defined by different authenticated location awareness technologies concurrently to improve the accuracy of the position of the portable electronic device 100 relative the virtual boundary 202 in real time.

FIG. 2 further discloses displayable computer instructions 400 which will be described in greater detail below.

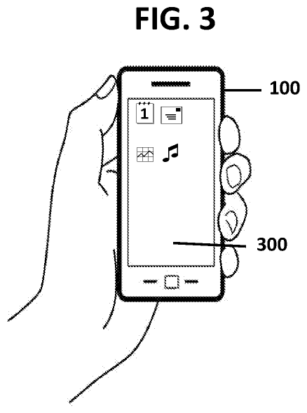

FIG. 3 shows a portable electronic device 100 in a user's hand. Though a smart phone is shown, as noted above portable electronic device 100 is not so limited and may be a variety of other types of portable electronic devices. FIG. 3 further shows a Graphical User Interface (GUI) 300 as is known by a person having ordinary skill in the art. The GUI 300 may comprise of various icons that, upon being selected by the user via the one or more input systems 105, may initiate a sequence of computer readable instructions stored on memory 102 to be read by processor 101 to implement a variety of different functions depending on the particular application. The GUI 300 will function within a portable electronic device 100 operating system which may be different from one portable device to another as is known by a person having ordinary skill in the art. Some of the icons and computer readable instructions associated therewith will come pre-installed on the portable electronic device memory 102 while others will be added and/or deleted by a user as preferred over time. Furthermore, some types or sets of computer readable instructions may be pre-installed on portable electronic device memory 102 but not be associated with any particular icon on the GUI 300 but rather are initiated upon some action of a user within an environment or simply by having the portable electronic device 100 in a particular environment (i.e. initiated by some action other than selecting an icon on the GUI 300).

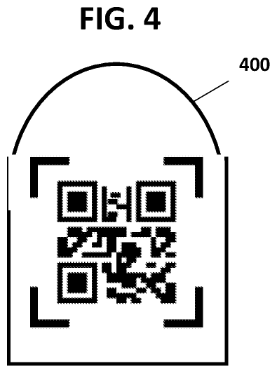

FIG. 4 depicts displayable computer instructions 400. Displayable computer instructions 400 can come in many shapes and forms. For example, and as shown in FIG. 4, displayable computer instructions 400 may be a Quick Response (QR) Code as is known by a person having ordinary skill in the art. But this invention is not so limited. Any type of displayable computer instructions may be implemented by this invention if they are readable by the portable electronic device 100. FIG. 1 shows displayable computer instructions 400 physically located on a wall at location 200. In this embodiment the displayable computer instructions could also be accompanied by an explanation of this invention and/or an invitation to a customer, client, consumer, or patient (i.e. a user) to use this invention. Displayable computer instructions 400 may be located anywhere at location 200 so as to be scanned or otherwise inputted by a user into portable electronic device 100. Displayable computer instructions 400 may be fixed (e.g. a poster, sign, picture or hand-out) or readily changeable. The latter could be achieved by creating displayable computer instructions 400 electronically on an electronic display. In this manner the displayable computer instructions 400 could be changed manually or automatically via a local or remote computer that is wired or wirelessly connected via wireless network 201 to said electronic display. This would allow for the displayable computer instructions 400 to be easily updated with new information periodically and to ensure a secure data exchange to authorized users.

In another embodiment, computer instructions similar to displayable computer instructions 400 could be wirelessly transmitted to a user's portable electronic device 100 via wireless network 201. Preferably, this data exchange could be initiated by user's portable electronic device 100 entering virtual boundary 202. This could be achieved with the use of a wireless network 201 interacting with one or more antennas 104 of portable electronic device 100. This could function in a similar manner as when a user is prompted to join a VPN when in proximity to a wireless router of a VPN as is known by a person having ordinary skill in the art.

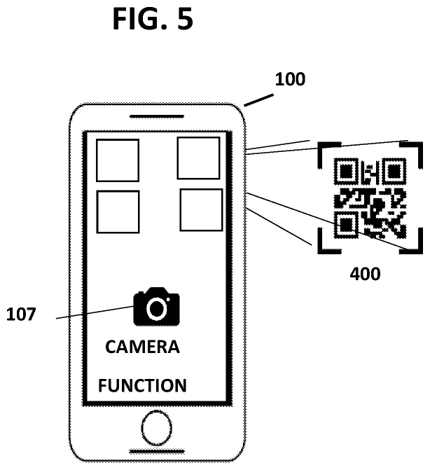

FIG. 5 depicts portable electronic device 100 scanning displayable computer instructions 400, represented in the figure as a QR Code. This may be achieved with the use of the one or more cameras 107 of portable electronic device 100 but is not intended to be so limited. One or more of the input systems 105 could also or alternatively be used to scan or read the displayable computer instructions 400. For example, a separate sensor for this purpose could be incorporated in portable electronic device 100. Pre-installed or user-installed computer readable instructions on memory 102 would que processor 101 that displayable computer instructions 400 have been scanned and initiate the reading of the displayable computer instructions 400. Displayable computer instructions 400 may comprise a variety of different types of instructions and no specific instruction is intended to be limiting on this invention. An example of a type of instruction that may be incorporated into displayable computer instructions 400 could be the initiation or opening of various pre-installed or user-installed computer instructions on the memory 102 of the portable electronic device 100. The displayable computer instructions 400 may also comprise raw data in the form of pictures or text that may be displayed to the user of the portable electronic device 100 on the display 103 via one or more of the pre-installed or user-installed computer instructions on memory 102.

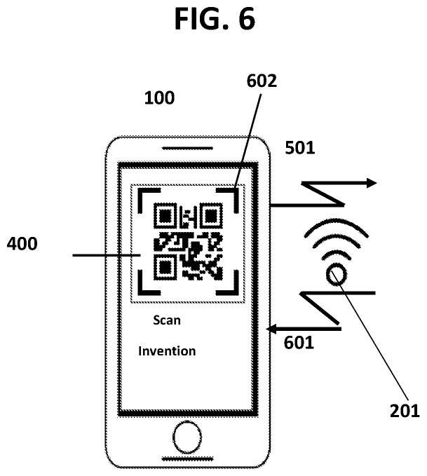

FIG. 6 shows the display 103 of portable electronic device 100 displaying the displayable computer instructions 400 with target assist features 602. Target assist features 602 are known to a person having ordinary skill in the art and are used to assist a user in properly scanning or inputting the displayable computer instructions 400. Target assist features 602 can be automatically initiated upon the input systems 105 (e.g. sensors) or cameras 107 being placed in close proximity to displayable computer instructions 400. In other words, there may be pre-installed or user-installed computer instructions on memory 102 that will allow for constant monitoring of an additional sensor or the camera 107 such that if and when the additional sensor or the camera 107 is within close proximity to displayable computer instructions 400 processor 101 will identify displayable computer instructions 400 and initiate target assist features 602 to allow user to properly scan or input the displayable computer instructions 400 onto memory 102 to be read and implemented by processor 101. The transmission signals 501 and receiving signals 601 depicted are standard function and processing over a wireless network 201 for a portable electronic device 100 and are commonly known and used by a person having ordinary skill in the art.

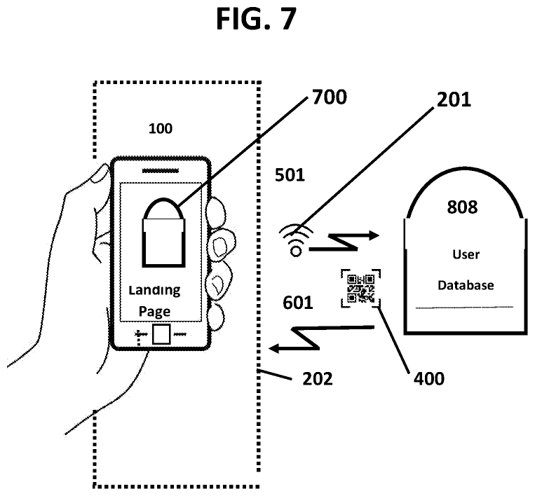

FIG. 7 shows an embodiment of the present invention where a user's portable electronic device 100 is within virtual boundary 202 and has recorded displayable computer instructions 400 as noted above onto memory 102 to be interpreted by processor 101. In this embodiment, displayable computer instructions 400 comprises instructions to processor 101 to initiate or open a specific pre-installed set of computer instructions on memory 102. More specifically, the pre-installed set of computer instructions in this embodiment are an internet browsing program as is known by a person having ordinary skill in the art. The displayable computer instructions 400 may further include instructions to processor 101 to use the internet browsing program to display a specific landing page 700 on the display 103 of the portable electronic device 100. The landing page 700 may comprise a website on the internet to facilitate data transfer between portable electronic device 100 and a remote memory (e.g. a web server) through secure wireless network 201. Though this embodiment discloses the use of a website this invention is not intended to be so limited. For example, the landing page 700 could comprise other wireless data transfer software that would allow for data to be transferred from a remote memory or a local memory to memory 102 on portable electronic device 100 (e.g. from a local server or from proprietor computer memory 802 to portable electronic device 100). FIG. 7 further discloses a user database 808 that will be described in greater detail below.

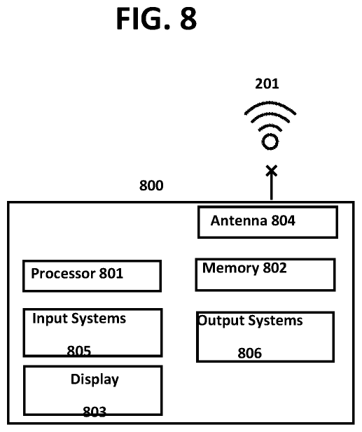

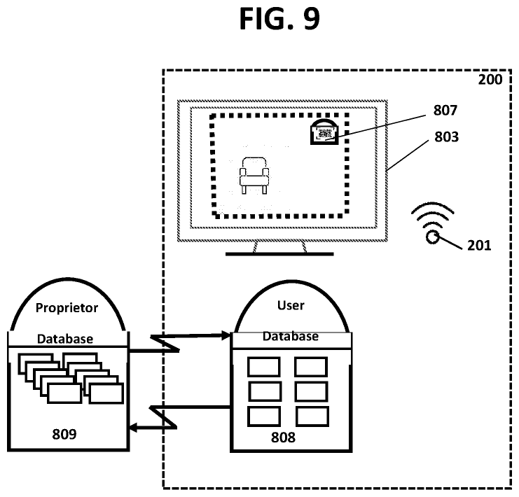

FIG. 8 shows a proprietor computer 800. Proprietor computer 800 comprises a proprietor computer processor 801, proprietor computer memory 802, proprietor computer displays 803, proprietor computer antennas 804, proprietor computer input systems 805 and proprietor computer output systems 806. As depicted, proprietor computer 800 is a desktop computer. However, this invention is not so limited. Proprietor computer 800 can be a portable electronic device similar to portable electronic device 100 as described above. Generally, proprietor computer 800 is any type of computing device that allows a proprietor to gain access to data stored on local or remote memory so as to allow proprietor to control the data and how it might be transferred to a user's portable electronic device 100 via wireless network 201. FIG. 9 shows proprietor computer 800 at location 200 but this invention is not so limited and the proprietor computer 800 can be anywhere.

FIG. 9 shows a proprietor set-up page 807. Proprietor set-up page 807 is similar to landing page 700 and is associated therewith. In this embodiment proprietor set-up page 807 is a website. However, this invention is not intended to be so limited. Proprietor set-up page 807 may comprise other wireless data transfer software that would allow for data to transfer wirelessly over wireless network 201 to a user's portable electronic device 100. Access to proprietor set-up page 807 may be contingent upon a fee-based subscription.

Proprietor set-up page 807 may further comprise a proprietor user interface that assists the proprietor in creating virtual boundary 202. For example, the proprietor set-up page 807 may allow the proprietor to create a virtual layout of location 200 so as to help determine the virtual boundary 202. Furthermore, depending on the authenticated location awareness technology used, proprietor set-up page 807 may allow the proprietor to test signal strengths around virtual boundary 202. For example, a portable electronic device similar to a user portable electronic device 100 could be used by the proprietor to mimic a user moving about location 200. The results of such testing can be input by the proprietor through the set-up page 807 thereby being stored on a remote memory of a remote server for use creating the virtual boundary 202 and maintaining the accuracy of the virtual boundary 202. The remote server comprising a pre-existing set of computer readable instructions that will implement a virtual boundary with the proprietor information being incorporated therein. The proprietor set-up page 807 may also be implemented if the virtual boundary 202 requires the use of physically detectable objects and/or sensors to assist the proprietor in strategically placing the physically detectable objects and/or sensors at location 200. For example, if location 200 is on a moving vehicle, such as a plane, train or bus, it may be desirable to use physically detectable objects or sensors to help create the virtual boundary 202 since the location 200 will be in motion and thus may not implement a virtual boundary 202 as effectively using antennas 104 and a wireless network 201 as would be the case in a fixed location. For some locations 200 it may be more desirable to use multiple different location awareness technologies to ensure the accuracy of the virtual boundary 202.

The proprietor set-up page 807 will also allow the proprietor to create a user database 808. The user database 808 may be customizable by the proprietor to suit the type of content the proprietor's customers, clients, and/or patients may desire. For example, a proprietor dentist may expect patients at his or her business location to desire a certain type of user database 808. The proprietor set-up page 807 may also suggest to a proprietor the type of user database 808 (i.e. a predetermined user database) commonly associated with a proprietor. Numerous predetermined user databases may be stored on a remote memory to be added to user database 808 upon approval by a proprietor or automatically based upon proprietor information being input on the proprietor set-up page 807. The user database 808 may be downloaded or populated from a proprietor database 809. The user database 808 may be stored on a local memory (e.g. a local server or proprietor computer memory 802) or may be stored on a remote memory (e.g. one of a plurality of different web servers). The user database 808 may be concurrently stored on a local memory and a remote memory.

The proprietor database 809 may be stored on a remote memory (e.g. one of a plurality of different web servers) or other memory source that may be transferrable to the user database 808. The data within the proprietor database 809 may be controlled by a provider. As used herein, a provider may be any person or corporation that provides data to a customer usually for a fee. The data within the proprietor database 809 may be a variety of different types of data. Generally, it is conceived that the data within the proprietor database 809 be subscription-based data that a user would normally need to pay a fee to access. For example, the data within the proprietor database 809 may comprise subscription-based television or video content, digital magazines, digital newspapers, audio files, websites, video games or any type of data that is not readily available to a user without paying a fee. The data within the proprietor database 809 could compromise live or streaming data to continuously be fed to the user database 808 or directly to the user portable electronic device 100 on demand. Though this embodiment provides for the data in the proprietor database 809 to be subscription-based data, this invention is not intended to be so limited. Some or all of the data could also be data that is otherwise free to a user but may otherwise be unknown to the user or a proprietor would desire for the user to be directed to such data while at the location 200. The extent of the access to the proprietor database 809 by the proprietor for transfer to the user database 808 may be based upon a fee or subscription paid by the proprietor. For example, a proprietor may pay a larger fee or subscription price for complete access to the entirety of data in the proprietor database 809 to the extent that the proprietor database 809 is equivalent to the user database 808. Alternatively, a proprietor may pay a smaller fee or subscription price to access only a limited amount of data in the proprietor database 809 that is then available for download or transfer or access in a user database 808. It is also within the scope of the present invention that a user may access the proprietor database 809 directly, thereby bypassing or forgoing the need for a user database 808, such access being dependent upon authentications as described herein. In this sense, the user database 808 may be only representative in nature so as to allow users and/or proprietors a convenient way to see what information is available to a user. The user database 808 may also be updated or changed from time to time with data from the proprietor database 809 as the provider data changes in the proprietor database 809. This may occur without needing any action from the proprietor. For example, if the proprietor would like to have available to his or her customers a particular digital magazine, the monthly digital magazines would automatically populate into the user database without any needed action from the proprietor. Similarly, or alternatively, the provider data available in the user database 808 may be randomly or purposefully changed from time to time to ensure new content is available for the users as well as to encourage proprietors to expand their subscriptions to include more provider content from the proprietor database 809.

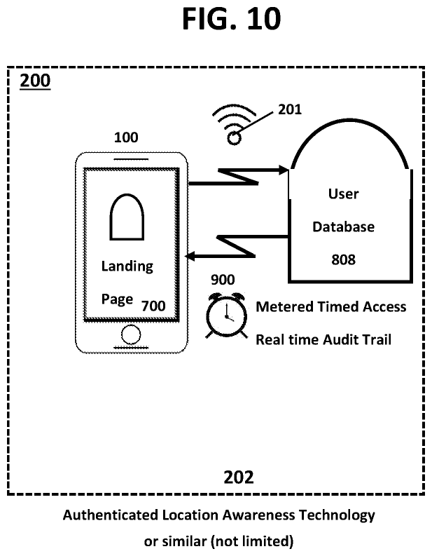

FIG. 10 discloses a user's portable electronic device 100 at location 200 within virtual boundary 202. After capturing displayable computer instructions 400 the processor 101 initiates pre-installed computer instructions to display landing page 700 on portable electronic device display 103. The landing page 700 may request authorizations from the user to install a set of virtual boundary computer readable instructions from a remote memory/server and to enable authenticated location awareness technologies to interact with portable electronic device antennas 104 and/or input systems 105 to implement virtual boundary 202. Furthermore, the landing page 700 may prompt the user for user information to be stored on a user engagement database 1300 to be discussed in more detail below. After these multi-factor authentications, a user may begin to access data on the user database 808 for transfer via wireless network 201 to portable electronic device memory 102 to be read by processor 101 for ultimate viewing and interaction by the user on display 103.

FIG. 10 further shows user data restrictions 900. User data restrictions 900 may comprise time limits on the duration of access to the user database 808. However, this invention is not intended to be so constrained. User data restrictions 900 may comprise any type of data restriction technique or set of computer readable instructions that is known by a person having ordinary skill in the art. For example, user data restrictions 900 may comprise a quantity limit of data that can be transferred from user database 808 to portable electronic device 100. Thus, user data restrictions 900 may comprise a real time monitoring of the data or packets of data that are being transferred from the user database 808 or the proprietor database 809 to the portable electronic device 100. Furthermore, user data restrictions 900 may comprise a combination of pre-determined limits to data usage amounts in a pre-determined time frame. If a time-based user data restriction 900 is implemented, applicant has found through experience and experimentation that the average customer, patient and/or client generally spends approximately 20 minutes in a proprietor waiting area before being seen. Therefore, a pre-determined user data restriction 900 may be implemented to optimize the amount of access to the user database 808 or proprietor database 809 thus striking the right balance of user enjoyment versus free access to otherwise fee-based provider data. Alternatively, if the user data restrictions 900 are based on the amount of data exchanged between the user database 808 or proprietor database 809 and the user portable electronic device 100, the applicant has found through experience and experimentation that most customers, patients and/or clients prefer to be able to complete or finish a particular data packet. For example, if a customer, patient and/or client is reading a digital magazine article, it would be an annoyance to the customer, patient and/or client to be prevented from having full access to said article. Therefore, to ensure maximum user satisfaction, a pre-determined amount of data may be associated with user data restrictions 900 so as to ensure an entire data packet is viewable (e.g. an entire magazine article, video, game, song, etc.) even after leaving virtual boundary 202 or location 200. Though user data restrictions 900 are depicted, it is also within the scope of this invention that there be no user data restrictions 900. Or that the user data restrictions 900 may be different depending on the location. For example, if this invention is being utilized at a person's home, it is conceivable that there be no user data restrictions 900 or that the user data restrictions 900 be less stringent than they otherwise would be at a proprietor business location. Furthermore, user data restrictions 900 may be variable, such as dependent on the type of provider data being accessed, and controllable by the proprietor and/or the provider.

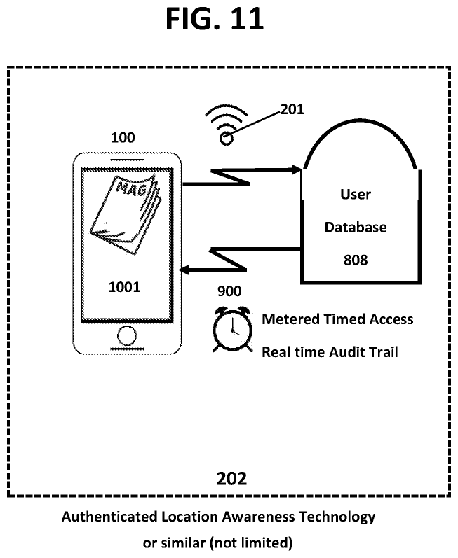

FIG. 11 discloses portable electronic device 100 with specific user interface 1001 on display 103. Specific user interface 1001 may vary depending on the type of data transferred from user database 808 or proprietor database 809 to portable electronic device 100. For example, specific user interface 1001 may be associated with different underlying file types as is known by a person having ordinary skill in the art depending on the type of data being viewed (i.e. video, text, images, audio, etc.). Furthermore, specific user interface 1001 may require additional computer readable instructions (e.g. programs or software) to be temporarily or permanently downloaded to memory 102 to be read and implemented by processor 101. Specific user interface 1001 may be custom-tailored by a specific provider depending on the content of the data. For example, a specific user interface for a video-on-demand provider will require different sets of computer readable instructions than another specific user interface associated with a digital magazine platform. For that matter, even within similar types of providers (e.g. digital magazines) there may be the need to have different specific user interfaces 1001 to present the data as the provider desires to enhance the user experience. Specific user interface 1001 may also comprise or be associated with computer readable instructions that are read by processor 101 to implement some or all of the input systems 105 and/or output systems 106 of the portable electronic device 100 so as to improve or enhance the user experience. For example, the specific user interface 1001 could implement touch screen inputs, voice commands, gesture controls, and/or haptic feedbacks to allow for a user to navigate through and interact with the associated data. In an alternative to the embodiments above, it is also within the scope of the present invention to have specific user interface 1001 as a more generic interface that allows for the viewing and interaction of a user with data between a number of different providers (i.e. a universal specific user interface).

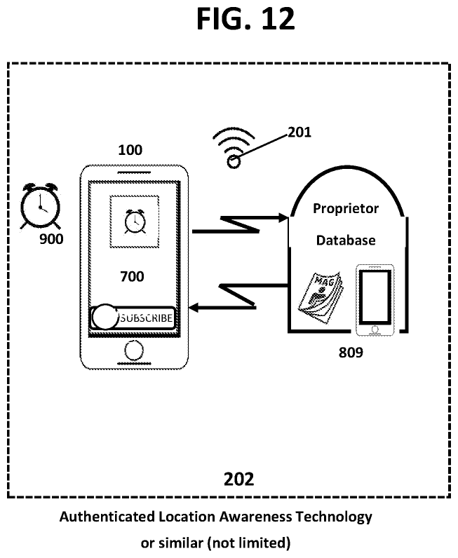

FIG. 12 discloses a user portable electronic device 100 being reverted to the landing page 700 or to a specific location within landing page 700 after user data restrictions 900 have taken effect. In other words, the requisite amount of time having access to the user database 808 or proprietor database 809 has elapsed and/or the limit amount of data has been exchanged between the portable electronic device 100 and the user database 808 or proprietor database 809. At this point it may be beneficial to a provider to offer the user a fee-based or subscription-based access to a proprietor database 809 and/or to a provider database where the user may access the specific provider data at any location for any amount of time as the fee or subscription allows. Furthermore, the proprietor may have the ability to extend or reset the user data restrictions 900 to allow the user to continue to access the user database 808 or proprietor database 809. This may be accomplished by refreshing or changing the displayable computer instructions 400 to be rescanned by the portable electronic device 100 or by providing a proprietor refresh code input to the portable electronic device 100. A variety of other reset techniques could be used as is known by a person having ordinary skill in the art and this invention is not intended to be so limited.

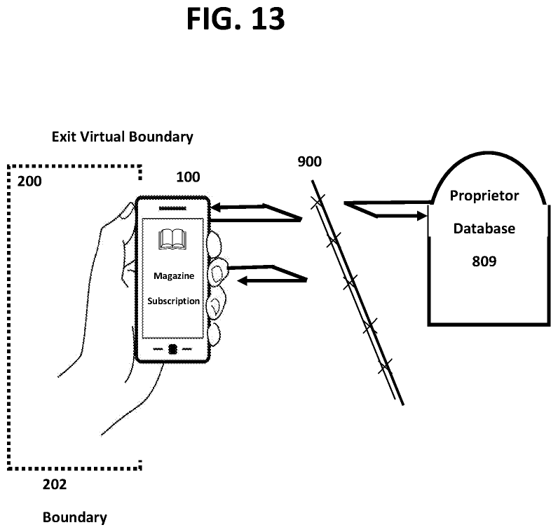

FIG. 13 discloses user and user portable electronic device 100 leaving location 200. More specifically, user and user portable electronic device 100 have gone outside of virtual boundary 202. Depending on the one or more location awareness technologies being used, portable electronic device antennas 104 and/or input systems 105 have sent information to processor 101 which, based upon computer readable instructions on memory 102, has instructed processor 101 to determine that the portable electronic device 100 is outside virtual boundary 202. Upon so doing, user access to user database 808 and/or proprietor database 809 is severed. In this manner, provider data is protected from unauthorized access but for when the user is at location 200 within virtual boundary 202. Should the user want to regain free access to the user database 808 or proprietor database 809 the user would need to reenter virtual boundary 202. Access to user database 808 or proprietor database 809 may be automatic upon the user portable electronic device 100 reentering the virtual boundary 202 and the antennas 104 or input systems 105 so indicating to processor 101. Alternatively, to regain access to the user database 808 or proprietor database 809 there may be additional steps required. For example, similar to how a user or proprietor may reset the user data restrictions 900 described above, upon reentering virtual boundary 202 a user may be required to have a proprietor refresh code input or rescan displayable computer instructions 400 or a combination thereof.

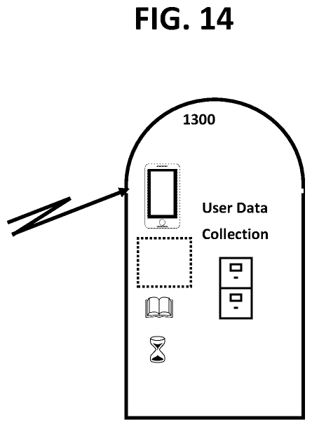

FIG. 14 discloses a user engagement database 1300. User engagement database 1300 is populated by data tracking techniques as is known by a person having ordinary skill in the art. For example, real time monitoring can be achieved of a user's interaction with the user database 808 and/or the proprietor database 809. This information can be invaluable to providers. For instance, a provider may be able to obtain information regarding which sets of provider data (e.g. a particular video/channel or a particular magazine article) that is most used or selected by users. Also, details of the user interaction may be recorded, such as how long a user spends interacting with particular sets of data and how a user interacts with particular sets of data. Such information will benefit providers as providing feedback to improve their products and services. Also, how proprietors use this invention, such as which sets of provider data is selected from the proprietor data base 809 to be used in the user database 809, can be recorded and used to improve the proprietor's and future proprietors' experience. For example, proprietor use data could be used to develop future pre-determined user databases. The types of user-interaction data that is tracked with data tracking techniques may be any type of data that is useful to users, proprietors, providers, or those that are implementing this invention. The user engagement database 1300 may receive real time monitoring data via wireless network 201. The user engagement database 1300 may be a portion of a memory (e.g. portable electronic device memory 102) to be uploaded to another memory at a specific time. The user engagement database 1300 may be located within portable electronic device memory 102, a local memory (e.g. proprietor computer memory 802 or a local server), the proprietor database 809, the user database 808, a provider database or other remote memory (e.g. a web server) for access by users, proprietors, providers or those that implement this invention.

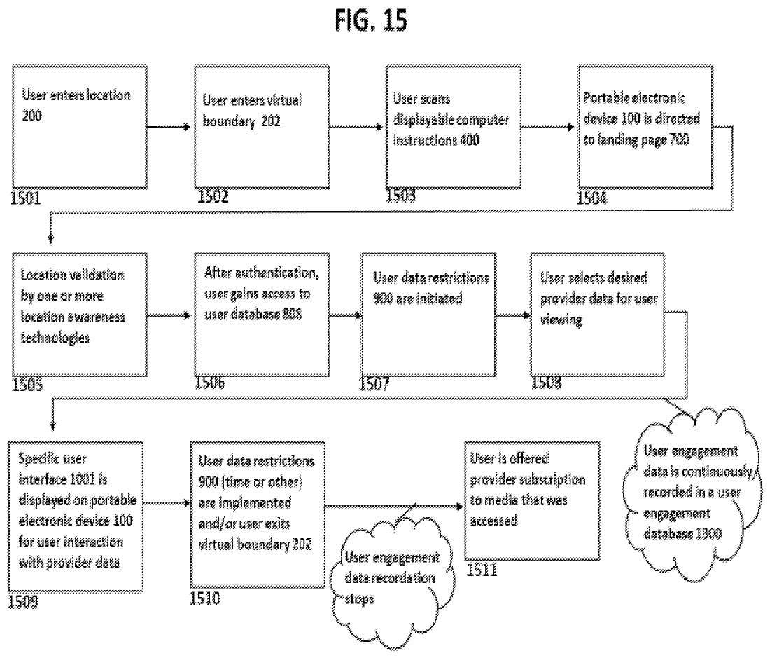

FIG. 15 discloses a method of user interaction with this invention. Though the method disclosed is a typical use of this invention, it is not intended to limit the scope of this invention in any way. Many variations of a method of user interaction are intended to be within the scope of this invention as disclosed herein. The intent of the method disclosed in FIG. 15 is to provide a clear understanding of this invention to a person having ordinary skill in the art.

Step 1501 discloses a customer, patient or client (i.e. a user) entering location 200. Step 1502 discloses a user entering virtual boundary 202. As noted above, virtual boundary 202 may be implemented by a variety of different location awareness technologies. Virtual boundary 202 may be controlled and pre-determined by a proprietor of location 200 and may be larger than, equal to or smaller than the area of location 200. If the virtual boundary 202 is larger than or equal to the area of location 200 then steps 1501 and 1502 may happen in reverse order or concurrently.

Step 1503 allows for a user to scan displayable computer instructions 400 with portable electronic device 100 as described above. Note that in an alternative embodiment the computer instructions within displayable computer instructions 400 could be transferred via wireless network 201 automatically to portable electronic device 100 upon the user entering location 200 and/or virtual boundary 202. This could result in an additional step where the user would be prompted as to whether or not to accept the computer readable instructions wirelessly.

Step 1504 discloses wherein the computer readable instructions read by the processor 101 directs portable electronic device 101 to display landing page 700. The landing page 700 is described as being a single page but this invention is not intended to be so limited. The landing page 700 may be a plurality of pages that are linked together for user interface as is known by a person having ordinary skill in the art.

Step 1505 recognizes wherein landing page 700, communicating with processor 101, implements or installs on memory 102 computer readable instructions associated with one or more location awareness technologies so as to utilize antennas 104 and/or input systems 105 and processor 101 to implement virtual boundary 202 in real time as well as additional authentications to confirm a user access to a user database 808 (step 1506). At this point, step 1507 shows user data restrictions 900 being initiated at a moment just after a user gains access to user database 808. Alternatively, user data restrictions 400 may be initiated after some predetermined event (e.g. once a particular file is opened, etc.) and/or may be variable depending upon a predetermined event (e.g. a user accessing an audio file may be allowed to listen to the file or a user accessing a digital article may be allowed to view the entire article).

Step 1508 depicts a user selecting a particular type of provider data available to user in the user database 808 or proprietor database 809. Thereafter FIG. 15 shows user engagement data being recorded, however this invention is not intended to be so limited and such depiction is representative only. For example, at any step shown in FIG. 15 user engagement data could be recorded to user engagement database 1300 for use by those that implement this invention, proprietors and/or providers. Step 1509 shows a specific user interface 1001 being implemented based upon the type of provider data selected by user. As noted above, specific user interface 1001 may be specific to a particular provider but may also be a universal specific user interface that functions with a variety of different types of providers or provider data.

Step 1510 discloses the moment when a user loses access to the provider data whether it be losing access to the user database 808, the proprietor database 809 or both. This may occur when user data restrictions 900 are implemented, when a user exits virtual boundary 202 or some combination thereof. At this point it is depicted in FIG. 15 that user engagement data recordation stops to the user engagement database 1300 but this invention is not so limited, and the user engagement data recordation could continue longer. For example, step 1511 shows wherein a user may be offered a provider subscription to the media that was accessed by the user. Whether a user subscribes to a provider may also be recorded to the user engagement database 1300.

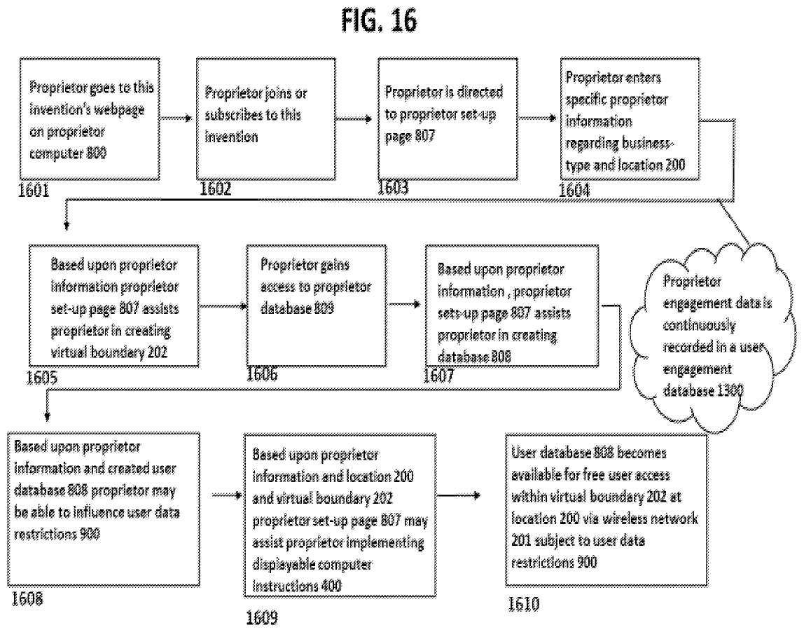

FIG. 16 discloses a method of proprietor interaction with this invention. Though the method disclosed is a typical use of this invention, it is not intended to limit the scope of this invention in any way. Many variations of a method of proprietor interaction are intended to be within the scope of this invention as disclosed herein. The intent of the method disclosed in FIG. 16 is to provide a clear understanding of this invention to a person having ordinary skill in the art.

The method of FIG. 16 begins with step 1601 wherein a proprietor goes to a webpage or similar and step 1602 initiates use of this invention. This could be accomplished in a variety of ways and this invention is not intended to be limited to online subscriptions. Also, as noted above, proprietor computer 800 is envisioned as being a desktop computer at the proprietor location but is not so limited. Proprietor computer 800 may be a portable electronic device like user portable electronic device 100. Once the proprietor joins, step 1603 depicts a proprietor being directed to proprietor set-up page 807. As noted above, proprietor set-up page 807 may have a plurality of interactions with proprietor computer 800 such as the installation of set-up computer readable instructions (e.g. software and/or programs) onto proprietor computer memory 802 to be read and implemented by proprietor processor 801 and thus to implement the various set-up functions as described herein. Furthermore, it should be understood that the information provided by the proprietor via the set-up page 807 will be incorporated into various pre-existing computer readable instructions (e.g. software or programs) saved on a remote memory associated with landing page 700 so that it will be eventually sent via wireless network 201 to a user portable electronic device 100 for implementation.

Step 1604 describes a proprietor entering information regarding the proprietor business type and location information. As noted above, the business type (or whether it is not a business but a home location) may affect the types of provider data available to the proprietor for population into a user database 808. Location information may also be important, as noted herein, in the implementation of location awareness technologies, and which technologies are to be used or need to be combined. For example, if the proprietor is an airline company and the location is an airplane, it may not be possible to use certain types of location awareness technologies (e.g. those that use cellular antennas). In such an example, it may be necessary to implement sensors and place physically detectable objects about the location 200 in order to establish a virtual boundary 202. Alternatively, it could be determined that such a location 200 may not need a virtual boundary 202 to provide authentications and protections of provider data (e.g. if a user cannot leave the location). Under such a scenario, it may be deemed that only user data restrictions 900 need be imposed versus other multi-factor authentications as described herein.

After step 1604 FIG. 16 depicts the recordation of proprietor engagement data into the user engagement database 1300. Note however that this is not intended to be limiting on this invention and is representative only. The recordation of proprietor engagement data can be occurring in the background throughout a proprietor's use of this invention (i.e. during any of the steps shown in FIG. 16). Step 1605 describes the proprietor set-up page 807 assisting a proprietor in creating a virtual boundary 202 as described throughout this specification. As a non-limiting example, this could use area dimensions of location 200 either provided by the proprietor or taken from other sources such as aerial photos, satellite imagery, etc. as is known in the art. Step 1605 could also involve the use of cellular signals, Wi-Fi signals, Bluetooth signals, GPS signals or other signal types/frequencies, or a combination thereof, to help determine the most accurate virtual boundary 202 for the proprietor location 200.

At step 1606 the proprietor gains access to the proprietor database 809. The proprietor database 809 is described in detail above, but generally comprises provider data that is available to all proprietors who may use this invention. At step 1607 a proprietor creates a user database 808 by transferring provider data from the proprietor database 809 to the user database 808. As noted above, this step may be the transfer of data from one memory location to another memory location but is not intended to be so limited. The creation of the user database 808 may be the designation of provider data within the proprietor database 809 as that which will ultimately be accessible to a user at the proprietor location 200. The creation of a user database 808 will allow a proprietor to conveniently see what provider data will be available to the proprietor's customers, clients or patients. Furthermore, in another embodiment, the user database 808 may be randomly populated or changed periodically with provider data from the proprietor database 809 over time so as to ensure new and updated provider data is available to the end users.

Step 1608 depicts the formation of user data restrictions 900 based upon proprietor information provided via the proprietor set-up page 807 and based upon the user database 808 that is created. The user data restrictions 900 are discussed extensively above. As an example, and as noted above, the user data restrictions 900 may vary depending upon the type of provider data accessed by a user. The user data restrictions 900 may also vary depending on the location 200 and/or the business type of the proprietor, or even the type of subscription/amount of fee paid by the proprietor to gain access to the provider data (e.g. a higher priced subscription may allow a proprietor to pass on more lenient user data restrictions 900 to their customers). This invention is not intended to be limited in scope to any particular user data restriction.

Step 1609 describes the proprietor set-up page 807 assisting the proprietor in implementing displayable computer instructions 400. Displayable computer instructions 400 are described extensively above. The proprietor set-up page 807 may be continuously accessible to the proprietor throughout the use of this invention (i.e. beyond just the set-up stage) and therefore may be used to update, change or refresh the displayable computer instructions 400 from time to time or as needed. The proprietor set-up page 807 is described as being a single page but this invention is not intended to be so limited. The proprietor set-up page 807 may be a plurality of pages that are linked together for a proprietor interface as is known by a person having ordinary skill in the art. Furthermore, the proprietor set-up page 807 may allow for a proprietor to real time track the location of users of the user database 808 at any given time, view the provider data that is being accessed by users at any given time, as well as see the status of user data restrictions 900 and may give the proprietor the ability to reset or remove user data restrictions 900.

Step 1610 is the launching of the user database 808 for free use by a proprietor's customers, clients or patients while within the virtual boundary 202 subject to user data restrictions 900 as discussed herein.

Various embodiments have been disclosed above to accurately describe to a person having ordinary skill in the art how to design, make and use this invention. However, a person having ordinary skill in the art will be able to substitute various equivalent elements to some or all of these embodiments which would therefore be within the scope of this invention. Furthermore, the claims below and equivalents are intended to define the scope of this invention.

We claim:

1. A system of providing data, the system comprising:
a portable electronic device comprising a processor;
a user database;
a wireless network;
a virtual boundary; and
displayable computer instructions,
wherein, the processor reads the displayable computer instructions to implement the virtual boundary to initiate data transfer between the user database and the portable electronic device over the wireless network.

2. The system of claim 1, wherein the wireless network comprises a cellular network.

3. The system of claim 1, wherein the displayable computer instructions comprise a quick response code.

4. The system of claim 1, wherein the user database is populated from a proprietor database.

5. The system of claim 1, wherein the data comprises subscription-based provider data.

6. The system of claim 5, wherein the subscription-based provider data comprises digital magazines, music, video games, on-demand video and live video.

7. The system of claim 5, wherein the data comprises additional computer instructions to implement a specific user interface on a display of the portable electronic device, the specific user interface varies depending on the subscription-based provider data accessed.

8. The system of claim 4, wherein the proprietor database comprises a plurality of remote servers associated with a respective plurality of providers.

9. The system of claim 1, wherein the data transfer is subject to user data restrictions.

10. A method of data exchange with a portable electronic device, the method comprising:
a user entering a virtual boundary with the portable electronic device; and
the user interacting with computer instructions associated with the virtual boundary;
wherein, after interacting with the computer instructions, a processor in the portable electronic device authenticates the portable electronic device being within the virtual boundary and allows data exchange between the portable electronic device and a user database over a wireless network.

11. The method of claim 10, wherein the interacting with the computer instructions comprises the user being prompted to authorize the computer instructions to be read by the processor.

12. The method of claim 10, wherein once data exchange begins between the portable electronic device and the user database user data restrictions begin.

13. The method of claim 12, wherein the user data restrictions comprise a time limit of 20 minutes.

14. The method of claim 10, wherein the user database comprises provider data and a plurality of specific user interfaces are associated with a respective plurality of the provider data.

15. The method of claim 10, wherein user engagement data is continuously recorded in a user engagement database.

16. The method of claim 12, wherein once the user data restrictions are implemented user access to the user database is stopped.

17. The method of claim 16, wherein the user database comprises subscription-based provider data, and after the user data restrictions are implemented the user is prompted with an offer to subscribe to the provider of the subscription-based provider data the user accessed.

18. The method of claim 11, wherein virtual boundary computer readable instructions implementing one or more location awareness technologies are transferred to the portable electronic device to be read by the processor to thereby implement the virtual boundary with the use of one or more antennas of the portable electronic device.

19. A method of providing data to a user, the method comprising:
a proprietor being authorized access to a proprietor set-up page;
the proprietor giving proprietor information to a remote server through the proprietor set-up page;
a virtual boundary being created based upon the proprietor information being incorporated into a pre-existing set of virtual boundary computer readable instructions on the remote server;
a user database being created from a proprietor database;
one or more user data restrictions being created based upon the proprietor information and the user database created; and
one or more displayable computer instructions being created;
wherein, the user database becomes accessible for data exchange with a portable electronic device of the user through a wireless network after a processor of the portable electronic device reads the one or more displayable computer instructions within the virtual boundary, the data exchange being subject to the one or more user data restrictions.

20. The method of claim 19, wherein the user database becomes a pre-determined user database based upon the proprietor information.
